(19) United States
(12) Patent Application Publication
(10) Pub. No.: US 2026/0044058 A1
(43) Pub. Date: Feb. 12, 2026

(54) MECHANICAL STRUCTURE OF CANTILEVER AND PAN-TILT-ZOOM CAMERA

(71) Applicant: TIANJIN HUALAI TECHNOLOGY CO., LTD., Tianjin (CN)

(72) Inventors: Shuxi ZHANG, Tianjin (CN); Zhibin PANG, Tianjin (CN); Yang GUO, Tianjin (CN); Guoqing WANG, Tianjin (CN); Daoqiu WANG, Tianjin (CN); Kechen AI, Tianjin (CN); Huaizhong XIE, Tianjin (CN)

(73) Assignee: TIANJIN HUALAI TECHNOLOGY CO., LTD., Tianjin (CN)

(21) Appl. No.: 19/365,778

(22) Filed: Oct. 22, 2025

Related U.S. Application Data
(63) Continuation of application No. PCT/CN2023/126917, filed on Oct. 26, 2023.

(30) Foreign Application Priority Data
Apr. 23, 2023 (CN) 202320932137.5

(51) Int. Cl. G03B 17/56; F16M 11/12; F16M 11/18; F16M 13/02; H04N 23/51; H04N 23/695

(52) U.S. Cl. CPC G03B 17/561; F16M 11/126; F16M 11/18; F16M 13/02; H04N 23/51; H04N 23/695

(57) ABSTRACT

A cantilever includes a gear shaft, a torsion spring, and a fastening member that is fixedly mounted inside a pan-tilt housing. The gear shaft rotationally fits the fastening member, a shaft shoulder of the gear shaft is recessed in a direction parallel to an axial direction of the shaft shoulder to form an annular accommodating groove, and the gear shaft is provided with a side opening communicating with the accommodating groove. The torsion spring is mounted in the accommodating groove, a limiting end portion that is of the torsion spring and that is close to a bottom of the accommodating groove extends out of the side opening, the side opening is configured to limit a position of the limiting end portion relative to the gear shaft, and an engagement end portion extends out of the accommodating groove and is connected to the fastening member gear shaft.

### CROSS-REFERENCE TO RELATED APPLICATIONS

This application is a continuation of International Patent Application No. PCT/CN2023/126917 with a filing date of Oct. 26, 2023, designating the United States, now pending, and further claims the priority to Chinese Patent Application No. 202320932137.5 with a filing date of Apr. 23, 2023. The content of the aforementioned applications, including any intervening amendments thereto, is incorporated herein by reference.

### TECHNICAL FIELD

The present application relates to the field of camera equipment technologies, and in particular, to a mechanical structure of a cantilever and a pan-tilt-zoom (PTZ) camera.

### BACKGROUND

A PTZ camera includes a pan-tilt housing and a camera housing hinged with the pan-tilt housing. A camera is mounted in the camera housing, and a motor is mounted in the pan-tilt housing. An output gear of the motor is engaged with a gear shaft, and a power output end of the gear shaft is fixedly connected to the camera housing. The output gear is engaged with the gear shaft, to implement relative rotation between the camera housing and the pan-tilt housing. However, there is usually a certain amount of backlash between the output gear and the gear shaft, affecting operational stability of the camera housing. Especially during reciprocating rotation of the camera housing, the backlash can cause minor jitter in an image, affecting image-shooting quality of the PTZ camera.

Therefore, how to provide a cantilever mechanical structure and a PTZ camera capable of improving the image-shooting quality is one of technical problems that need to be resolved by those skilled in the art.

### SUMMARY OF PRESENT INVENTION

An objective of the present application is to provide a cantilever mechanical structure and a PTZ camera, to compensate for backlash between a gear shaft and an output gear of a motor, and ensure image-shooting quality of the PTZ camera.

To achieve the above objective, the present application provides the following technical solutions.

According to a first aspect, the present application provides a cantilever mechanical structure, including: a gear shaft, a torsion spring, and a fastening member that is fixedly mounted inside a pan-tilt housing, where
the gear shaft rotationally fits the fastening member, a shaft shoulder of the gear shaft is recessed in a direction parallel to an axial direction of the gear shaft to form an annular accommodating groove, and the gear shaft is provided with a side opening communicating with the accommodating groove; and
the torsion spring is mounted in the accommodating groove, a limiting end portion that is of the torsion spring and that is close to a bottom of the accommodating groove extends out of the side opening, the side opening is configured to limit a position of the limiting end portion relative to the gear shaft, and an engagement end portion that is of the torsion spring and that is close to a top of the accommodating groove extends out of the accommodating groove and is connected to the fastening member.

Further, the gear shaft includes an inner shaft body, a gear, and an outer shaft collar;
the inner shaft body rotationally fits the fastening member, the gear and the outer shaft collar are both fixedly sleeved on the inner shaft body, and the gear is located on a side that is of the outer shaft collar and that is away from the fastening member; and
an end surface that is of the outer shaft collar and that faces the fastening member is recessed to form the accommodating groove, and the outer shaft collar is provided with the side opening.

Further, the side opening extends in a direction towards the gear from an end portion that is of the outer shaft collar and that is away from the gear.

Further, the torsion spring is formed by bending a spring wire, the spring wire has a constant diameter throughout, and a width of the side opening is equal to the diameter of the spring wire.

Further, the torsion spring further includes a spiral portion, and the spiral portion is sleeved on the inner shaft body;
the limiting end portion and the engagement end portion are respectively connected to two ends of the spiral portion;
the limiting end portion extends out of the side opening and is wound around an outer circumferential surface of the outer shaft collar; and
the engagement end portion extends out of the accommodating groove and is engaged with the fastening member.

Further, the limiting end portion includes a first external extension section and a circumferential extension section, the first external extension section is connected between the spiral portion and the circumferential extension section, the first external extension section passes through the side opening, and the circumferential extension section is wound around the outer circumferential surface of the outer shaft collar.

Further, the engagement end portion includes a second external extension section, an axial extension section, and a bent section that are connected in sequence, an end that is of the second external extension section and that is away from the axial extension section is connected to the spiral portion, an extension direction of the axial extension section is parallel to an axial direction of the inner shaft body and penetrates the fastening member, and the bent section is bent relative to the axial extension section.

According to a second aspect, the present application further provides a PTZ camera, including the cantilever mechanical structure according to the foregoing solution.

Further, a camera housing, a pan-tilt housing, and a motor are further included, where
the pan-tilt housing is hinged with the camera housing, and a power output end of the gear shaft is fixedly connected to the camera housing; and
the motor and the fastening member are fixedly mounted inside the pan-tilt housing, and an output gear of the motor is engaged with the gear shaft.

Further, a transmission ratio between the gear shaft and the output gear of the motor is 1:1.

The cantilever mechanical structure and the PTZ camera provided in the present application has the following beneficial effects:

Compared to the conventional technology, in the cantilever mechanical structure provided in the first aspect of the present application, the gear shaft rotationally fits the fastening member, and the torsion spring is disposed between the gear shaft and the fastening member. The torsion spring is mounted in the accommodating groove of the gear shaft, and a torque of the torsion spring can be controlled by using space of the accommodating groove, preventing uncontrollable effects caused by excessive deformation. The torsion spring between the gear shaft and the fastening member has a certain pre-tightening force to compensate for backlash between the gear shaft and the output gear of the motor, effectively avoiding minor jitter in an image during reciprocating rotation of the camera housing. When the fastening member rotates relative to the gear shaft, the torsion spring can also provide a damping force through elastic deformation thereof for the camera housing fixedly mounted to the fastening member and the fastening member, thereby ensuring image-shooting quality of the PTZ camera.

Compared with the conventional technology, the PTZ camera provided in the second aspect of the present application includes the cantilever mechanical structure provided in the first aspect of the present application, thereby achieving all of the beneficial effects of the cantilever mechanical structure provided in the first aspect of the present application.

### BRIEF DESCRIPTION OF THE DRAWINGS

To describe the technical solutions in the specific implementations of the present application or the conventional technology more clearly, the drawings required for describing the specific implementations or the conventional technology are briefly described below. Apparently, the drawings in the following description show merely some implementations of the present application, and those of ordinary skill in the art may still derive other drawings from these drawings without creative efforts.

FIG. 1 is a schematic diagram of a three-dimensional structure of the interior of a pan-tilt housing (without a motor) according to an embodiment of the present application;

FIG. 2 is a schematic diagram of a three-dimensional structure of the interior of a pan-tilt housing according to an embodiment of the present application;

FIG. 3 is a schematic diagram of a three-dimensional structure of fitting between a gear shaft and a torsion spring according to an embodiment of the present application;

FIG. 4 is a schematic diagram of a three-dimensional structure of a gear shaft according to an embodiment of the present application;

FIG. 5 is a schematic diagram of a side-view structure of a gear shaft according to an embodiment of the present application;

FIG. 6 is a schematic diagram of a three-dimensional structure of a torsion spring according to an embodiment of the present application; and

FIG. 7 is a schematic diagram of an external three-dimensional structure of a PTZ camera according to an embodiment of the present application.

Reference numerals: 1, gear shaft; 11, accommodating groove; 12, inner shaft body; 13, gear; 14, outer shaft collar; 141, side opening; 2, torsion spring; 21, limiting end portion; 211, first external extension section; 212, circumferential extension section; 22, engagement end portion; 221, second external extension section; 222, axial extension section; 223, bent section; 23, spiral portion; 3, pan-tilt housing; 4, fastening member; 41, arc-shaped surface; 5, camera housing; 6, motor; and 61, output gear.

### DETAILED DESCRIPTION OF THE EMBODIMENTS

The following clearly and completely describes the technical solutions of the present disclosure with reference to the embodiments. Apparently, the described embodiments are merely some rather than all of the embodiments of the present disclosure. All other embodiments obtained by a person of ordinary skill in the art based on the embodiments of the present application without creative efforts shall fall within the protection scope of the present application.

It should be noted that in the description of the present disclosure, the terms such as “center”, “top”, “bottom”, “left”, “right”, “vertical”, “horizontal”, “inner” and “outer” indicate the orientation or position relationships based on the drawings. These terms are merely intended to facilitate description of the present disclosure and simplify the description, rather than to indicate or imply that the mentioned device or element must have a specific orientation and must be constructed and operated in a specific orientation. Therefore, these terms should not be construed as a limitation to the present disclosure. Moreover, the terms “first”, “second”, and “third” are used only for the purpose of description, and are not intended to indicate or imply relative importance.

In the description of the present disclosure, it should be noted that, unless otherwise clearly specified, meanings of terms “install”, “connected with”, and “connected to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present application based on specific situations.

The specific implementations of the present disclosure are described in detail below with reference to the accompanying drawings. It should be understood that the specific implementations described herein are merely intended to illustrate and interpret the present disclosure, rather than to limit the present disclosure.

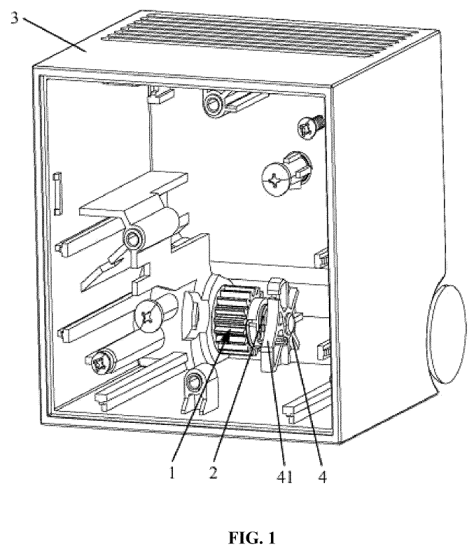

An embodiment of the first aspect of the present application aims to provide a cantilever mechanical structure. As shown in FIG. 1 to FIG. 4, the cantilever mechanical structure includes a gear shaft 1, a torsion spring 2, and a fastening member 4 that is fixedly mounted inside a pan-tilt housing 3. The gear shaft 1 rotationally fits the fastening member 4. A shaft shoulder of the gear shaft 1 is recessed in a direction parallel to an axial direction of the gear shaft to form an annular accommodating groove 11. The gear shaft 1 is provided with a side opening 141 communicating with the accommodating groove 11. The torsion spring 2 is mounted in the accommodating groove 11. A limiting end portion 21 that is of the torsion spring 2 and that is close to a bottom of the accommodating groove 11 extends out of the side opening 141. The side opening 141 is configured to limit a position of the limiting end portion 21 relative to the gear shaft 1. An engagement end portion 22 that is of the torsion spring 2 and that is close to a top of the accommodating groove 11 extends out of the accommodating groove 11 and is connected to the fastening member 4.

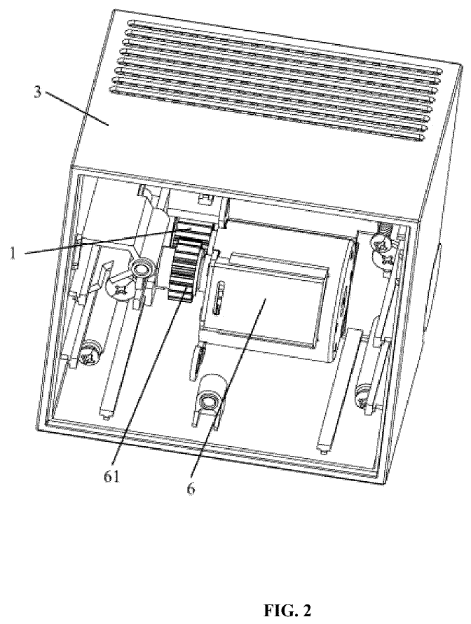

When the pan-tilt housing 3 is required to rotate relative to a camera housing 5, as shown in FIG. 2, a motor 6 fixedly connected inside the pan-tilt housing 3 is started. Since a power output end of the gear shaft 1 is fixedly connected to the camera housing 5, and an output gear 61 of the motor 6 is engaged with the gear shaft 1, under the driving of the output gear 61, the pan-tilt housing 3 and the camera housing 5 rotate relative to each other. Compared with the conventional technology, the cantilever mechanical structure is provided with the torsion spring 2 having a certain pre-tightening force between the gear shaft 1 and the fastening member 4. The torsion spring 2 can compensate for backlash between the gear shaft 1 and the output gear 61 of the motor 6, effectively preventing minor image jitter during reciprocating rotation of the camera housing 5. When the gear shaft 1 rotates relative to the fastening member 4, the torsion spring 2 can also provide a damping force through elastic deformation thereof for the gear shaft 1, thereby ensuring image-shooting quality of the PTZ camera.

The following describes the structure of the gear shaft 1 in detail.

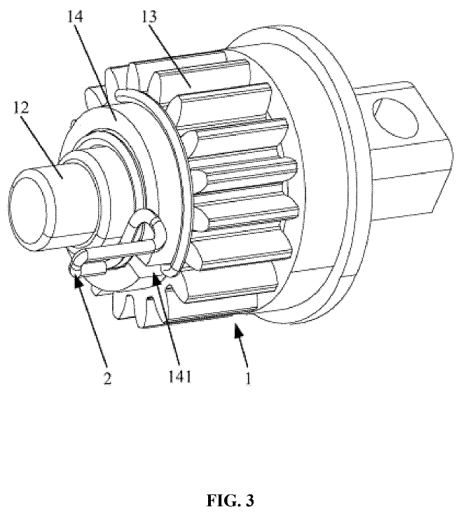

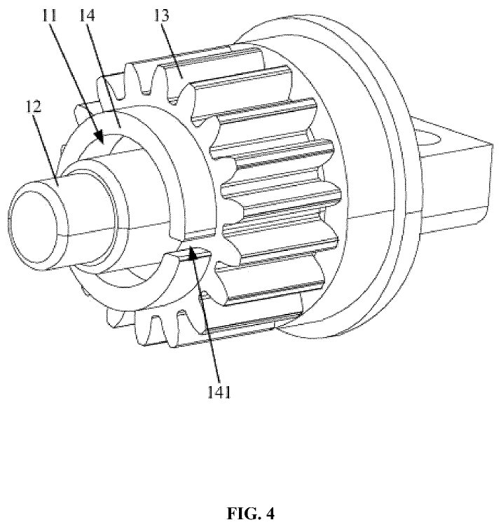

In some embodiments, as shown in FIG. 3 and FIG. 4, the gear shaft 1 includes an inner shaft body 12, a gear 13, and an outer shaft collar 14. One end of the inner shaft body 12 may be fixedly connected to the camera housing 5, and another end of the inner shaft body 12 may rotationally fit the fastening member 4. Both the gear 13 and the outer shaft collar 14 are fixedly sleeved on the inner shaft body 12. The gear 13 is located on a side that is of the outer shaft collar 14 and that is away from the fastening member 4.

An end face that is of the outer shaft collar 14 and that faces the fastening member 4 can be regarded as a shaft shoulder of the gear shaft 1. The end face of the outer shaft collar 14 is recessed to form the accommodating groove 11. The outer shaft collar 14 is provided with a side opening 141 communicating with the accommodating groove 11.

The gear 13 has a reference diameter d2=9 mm, a number of teeth Z=18, and a module m=0.5 mm.

In addition, the side opening 141 may extend close to the gear 13 from an end portion that is of the outer shaft collar 14 and that is away from the gear 13. This allows the torsion spring 2 to be inserted into the accommodating groove 11 from the end portion of the outer shaft collar 14, facilitating mounting of the torsion spring (2).

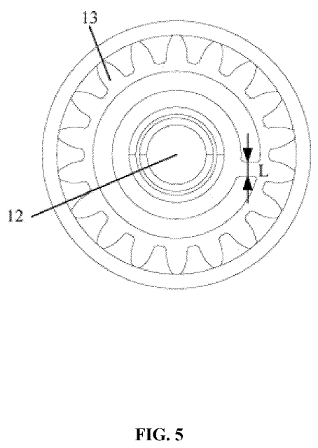

It may be understood that an extension direction of the side opening 141 may be considered as a length direction of the side opening 141. As shown in FIG. 5, a width of the side opening 141 is equal to a perpendicular distance L between two surfaces that form the side opening 141 and that are on the outer shaft collar 14. The following describes the structure of the torsion spring 2 in detail.

The torsion spring 2 is formed by bending a spring wire, and the spring wire has a constant diameter throughout.

A torque value of the torsion spring is as follows:

$$F = \frac{{E ( {d}_{1} )}^{4} ∅}{1167 {D}_{m} RNR}$$

where F indicates the torque of the torsion spring; E indicates a modulus of rigidity of the spring wire; d1 indicates the diameter of the spring wire; φ indicates a rotation angle; Dm indicates a mean diameter of the torsion spring (outer diameter of torsion spring 2—diameter of the spring wire); P indicates pi (for example, the value is 3.1416); N indicates a number of active coils; and R indicates a load force arm.

Verification is performed by using the above formula to ensure that the torsion spring 2 meets design requirements, that is, it is guaranteed that a pre-tightening force of the torsion spring 2 meets the design requirements after assembly is completed.

In some embodiments, the width of the side opening 141 may be equal to the diameter of the spring wire. This ensures that after the spring wire at the limiting end portion 21 can be precisely retained at the side opening 141 after extending out of the side opening 141, thereby limiting a position of the limiting end portion 21 relative to the gear shaft 1, and preventing rotation of the limiting end portion (21) relative to the gear shaft (1). In other words, a circumferential position of an end of the torsion spring (2) is limited.

Certainly, the width of the side opening 141 may alternatively be slightly larger than the diameter of the spring wire.

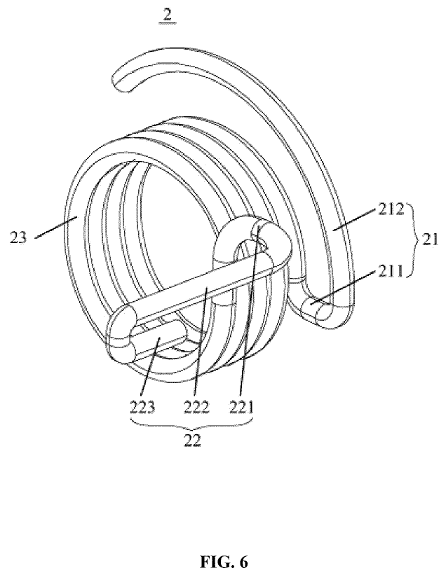

In some embodiments, as shown in FIG. 6, the torsion spring 2 further includes a spiral portion 23. The spiral portion 23 is sleeved on the exterior of the inner shaft body 12 and is configured to provide a damping force through deformation thereof during operation.

The limiting end portion 21 and the engagement end portion 22 are respectively connected to two ends of the spiral portion 23. The limiting end portion 21, the engagement end portion 22, and the spiral portion 23 may have an integrated structure.

The limiting end portion 21 extends out of the side opening 141 and is wound around an outer circumferential surface of the outer shaft collar 14. This can be regarded as one end of the torsion spring 2 being stably mounted on the gear shaft 1. The engagement end portion 22 extends out of the accommodating groove 11 and is engaged with the fastening member 4 This can be regarded as another end of the torsion spring 2 being stably installed on the fastening member 4. In this way, a magnitude of the pre-tightening force of the torsion spring 2 can be controlled during assembly.

Specifically, as shown in FIG. 6, the limiting end portion 21 includes a first external extension section 211 and a circumferential extension section 212. The first external extension section 211 is connected between the spiral portion 23 and the circumferential extension section 212. The first external extension section 211 is configured to extend in a direction away from an axis of the inner shaft body 12 so as to pass through the side opening 141. The circumferential extension section 212 is wound around an outer circumferential surface of the outer shaft collar 14. In this way, when the torsion spring 2 deforms, the circumferential extension section 212 can enhance limitation on the limiting end portion 21 through abutment thereof against the outer circumferential surface of the outer shaft collar 14, thereby guaranteeing stability of a position of the end portion of the torsion spring 2 relative to the gear shaft 1.

A plane on which the extension direction of the first external extension section 211 is located is preferably perpendicular to the axis of the gear shaft 1.

In some embodiments, as shown in FIG. 6, the engagement end portion 22 includes a second external extension section 221, an axial extension section 222, and a bent section 223 that are connected in sequence. An end that is of the second external extension section 221 and that is away from the axial extension section 222 is connected to the spiral portion. An extension direction of the axial extension section 222 is parallel to an axial direction of the inner shaft body 12 and penetrates the fastening member 4. The bent section 223 is bent relative to the axial extension section 222. The extension direction of the bent section 223 after bending is preferably parallel to the extension direction of the axial extension section 222, that is, the axial extension section 222 and the bent section 223 are bent into a U-shape.

The bent section 223 may be disposed to fasten the engagement end portion 22 to the fastening member 4, thereby limiting an axial position of the torsion spring 2 relative to the gear shaft 1.

The second external extension section 221 is configured to extend in a direction away from the axis of the inner shaft body 12. A plane on which an extension direction of the second external extension section 221 is located is preferably parallel to the plane on which the extension direction of the first external extension section 211 is located. An extension length of the second external extension section 221 is preferably equal to an extension length of the first external extension section 211. In this way, when the torsion spring 2 deforms, a force arm of a torque acting on the gear shaft 1 is substantially the same as a force arm of a torque acting on the fastening member 4.

The following describes the structure of the fastening member 4 in detail.

The fastening member 4 can be fixedly installed within the pan-tilt housing 3 by using processing methods including welding, integral molding, or the like. The fastening member 4 may be provided with a through hole for the axial extension section 222 to pass through. The axial extension section 222 passes through the through hole and is then bent to form the bent section 223, thereby fastening the torsion spring 2 to the fastening member 4. The fastening member 4 may also be provided with a rib plate for enhancing strength of the fastening member 4.

As shown in FIG. 1, the outer circumferential surface of the fastening member 4 may have an arc-shaped surface 41. The arc-shaped surface is in contact with a housing of the motor 6.

An embodiment of the second aspect of the present application aims to provide a PTZ camera. The PTZ camera provided in the embodiment of the second aspect of the present application comprises the cantilever mechanical structure.

The PTZ camera provided in the second aspect of the present application includes the cantilever mechanical structure provided in the embodiments of the first aspect of the present application, thereby achieving all of the beneficial effects of the cantilever mechanical structure provided in the embodiments of the first aspect of the present application.

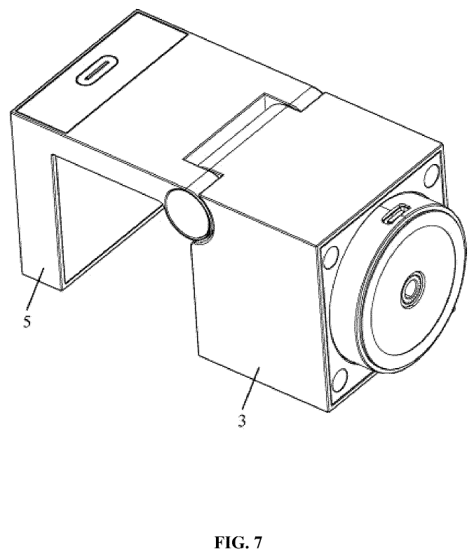

In some embodiments, as shown in FIG. 2 and FIG. 7, the PTZ camera further includes a camera housing 5, a pan-tilt housing 3, and a motor 6.

The pan-tilt housing 3 is hinged with the camera housing 5, and a power output end of the gear shaft 1 is fixedly connected to the camera housing 5. The power output end of the gear shaft 1 can be an end portion that is of the gear shaft 1 and that is away from the fastening member 4.

The motor 6 and the fastening member 4 are fixedly mounted inside the pan-tilt housing 3, and an output gear 61 of the motor 6 is engaged with a gear 13 on the gear shaft 1.

In some embodiments, a transmission ratio between the gear shaft 1 and the output gear 61 of the motor 6 is 1:1. In this way, a rotation speed of the camera housing 5 is the same as a rotation speed output by the motor 6. A power of a power output shaft of the motor 6 is uniformly distributed and output, and a rotation direction of the power output shaft of the motor 6 is changed. In addition, the power output shaft of the motor 6 and the gear shaft 1 are disposed opposite to each other, eliminating a bending moment caused by the power output of the power output shaft of the motor 6.

Finally, it should be noted that the foregoing embodiments are merely used to explain the technical solutions of the present application, but are not intended to limit the present application. Although the present application is described in detail with reference to the foregoing embodiments, the person of ordinary skill in the art should understand that they can still modify the technical solutions described in the foregoing embodiments, or make equivalent substitutions on some or all technical features therein. These modifications or substitutions do not make the essence of the corresponding technical solutions deviate from the spirit and scope of the technical solutions of the embodiments of the present application.

What is claimed is:

1. A cantilever, comprising: a gear shaft (1), a torsion spring (2), and a fastening member (4) that is fixedly mounted inside a pan-tilt housing (3), wherein
the gear shaft (1) rotationally fits the fastening member (4), a shaft shoulder of the gear shaft (1) is recessed in a direction parallel to an axial direction of the gear shaft to form an annular accommodating groove (11), and the gear shaft (1) is provided with a side opening (141) communicating with the accommodating groove (11); and
the torsion spring (2) is mounted in the accommodating groove (11), a limiting end portion (21) that is of the torsion spring (2) and that is close to a bottom of the accommodating groove (11) extends out of the side opening (141), the side opening (141) is configured to limit a position of the limiting end portion (21) relative to the gear shaft (1), and an engagement end portion (22) that is of the torsion spring (2) and that is close to a top of the accommodating groove (11) extends out of the accommodating groove (11) and is connected to the fastening member (4).

2. The cantilever according to claim 1, wherein the gear shaft (1) comprises an inner shaft body (12), a gear (13), and an outer shaft collar (14);
the inner shaft body (12) rotationally fits the fastening member (4), the gear (13) and the outer shaft collar (14) are both fixedly sleeved on the inner shaft body (12), and the gear (13) is located on a side that is of the outer shaft collar (14) and that is away from the fastening member (4); and
an end surface that is of the outer shaft collar (14) and that faces the fastening member (4) is recessed to form the accommodating groove (11), and the outer shaft collar (14) is provided with the side opening (141).

3. The cantilever according to claim 2, wherein the side opening (141) extends in a direction towards the gear (13) from an end portion that is of the outer shaft collar (14) and that is away from the gear (13).

4. The cantilever according to claim 2, wherein the torsion spring (2) is formed by bending a spring wire, the spring wire has a constant diameter throughout, and a width of the side opening (141) is equal to the diameter of the spring wire.

5. The cantilever according to claim 2, wherein the torsion spring (2) further comprises a spiral portion (23), and the spiral portion (23) is sleeved on the inner shaft body (12);
the limiting end portion (21) and the engagement end portion (22) are respectively connected to two ends of the spiral portion (23);
the limiting end portion (21) extends out of the side opening (141) and is wound around an outer circumferential surface of the outer shaft collar (14); and
the engagement end portion (22) extends out of the accommodating groove (11) and is engaged with the fastening member (4).

6. The cantilever according to claim 5, wherein the limiting end portion (21) comprises a first external extension section (211) and a circumferential extension section (212), the first external extension section (211) is connected between the spiral portion (23) and the circumferential extension section (212), the first external extension section (211) passes through the side opening (141), and the circumferential extension section (212) is wound around the outer circumferential surface of the outer shaft collar (14).

7. The cantilever according to claim 5, wherein the engagement end portion (22) comprises a second external extension section (221), an axial extension section (222), and a bent section (223) that are connected in sequence, an end that is of the second external extension section (221) and that is away from the axial extension section (222) is connected to the spiral portion (23), an extension direction of the axial extension section (222) is parallel to an axial direction of the inner shaft body (12) and penetrates the fastening member (4), and the bent section (223) is bent relative to the axial extension section (222).

8. A pan-tilt-zoom (PTZ) camera, comprising the cantilever according to claim 1.

9. The PTZ camera according to claim 8, further comprising: a camera housing (5), a pan-tilt housing (3), and a motor (6), wherein the pan-tilt housing (3) is hinged with the camera housing (5), and a power output end of the gear shaft (1) is fixedly connected to the camera housing (5); and the motor (6) and the fastening member (4) are fixedly mounted inside the pan-tilt housing (3), and an output gear (61) of the motor (6) is engaged with the gear shaft (1).

10. The PTZ camera according to claim 9, wherein a transmission ratio between the gear shaft (1) and the output gear (61) of the motor (6) is 1:1.
